(19) United States
(12) Patent Application Publication
(10) Pub. No.: US 2010/0325012 A1
(43) Pub. Date: Dec. 23, 2010

(54) METHOD OF CONTROLLING RELEASE OF A DATA PRODUCT

(75) Inventor: Timothy John Standish, Prahran East (AU)

Correspondence Address: Workman Nydegger;1000 Eagle Gate Tower, 60 East South Temple, Salt Lake City, UT, 84111, US

(73) Assignee: RIGHT-COPY PROPERTIES PTY LTD, Prahran East, Victoria (AU)

(21) Appl. No.: 12/528,265

(22) PCT Filed: Feb. 26, 2008
(86) PCT No.: PCT/AU2008/000251

§ 371 Date: Aug. 21, 2009

Related U.S. Application Data
(60) Provisional application No. 60/915,795, filed on May 3, 2007.

(30) Foreign Application Priority Data
Feb. 28, 2007 (AU) 2007901045

(51) Int. Cl. G06F 9/46; G06Q 30/00; H04L 9/00

(52) U.S. Cl. 705/26.8; 719/328; 713/189

(57) ABSTRACT

A computer implemented method of controlling release of a data product to a host, comprising: providing a data parcel to a host comprising: (i) a payload interpreter accessible by an interface application program interface (API) for operation by the host and (ii) a data payload readable by the payload interpreter comprising reference data describing at least one data product; accessing the data parcel with the interface API; enabling the data parcel in response to the data parcel being accessed with the interface API; and determining that the data parcel is enabled before allowing the host to operate the payload interpreter to read part or all of the data payload.

This application is based on, and claims benefit of, Australian Patent Application No. 2007901045 filed 28 Feb. 2007 and U.S. Patent Application No. 60/915,795 filed 3 May 2007.

### FIELD OF INVENTION

The present invention relates to digital rights distribution and more specifically to a method of controlling release of a data product to a host.

### BACKGROUND TO THE INVENTION

In today's market place, products that can be represented digitally such as software and music are often delivered electronically.

While electronic distribution has the advantage that it allows a wide market reach, such product distribution methods have the disadvantage that once the data has been released from a controlled environment, there is an inherent risk that the data product will be distributed to others without authorisation. Obviously, this has a financial impact on the owners of the intellectual property rights in the data product as they are not able to redeem funds for all copies of the data product in use in the market.

To mitigate against the losses caused by copying of electronic products, electronic distribution technology has been developed to provide copy protection. Most electronic distribution technology centres largely on the use of encryption to prevent the production of illegal replicas when the products are taken up and enabled by the end user. Generally, the techniques that are used to distribute such data are resistant to abuse as long as their activation is enforced using on-line registration over the internet.

Existing systems also assume that customers will obtain the digital product from a distributor and that, when a customer buys a digital rights management protected digital product, the recipient must acquire a licence in order to access the protected material, typically by decrypting an encrypted data product.

A feature of existing systems is that the licensing is often only checked at the point of installation, or on initial launch of the digital product.

Accordingly, there is a need for improved techniques that can be employed in the management of digital rights, and those techniques should be designed to aid rather than hamper ease of consumer take up.

### SUMMARY OF THE INVENTION

In a first aspect, the invention provides a computer implemented method of controlling release of a data product to a host, comprising:
providing a data parcel to a host comprising: (i) a payload interpreter accessible by an interface API for operation by the host and (ii) a data payload readable by the payload interpreter comprising reference data describing at least one data product;
accessing the data parcel with the interface API;
enabling the data parcel in response to the data parcel being accessed with the interface API; and determining that the data parcel is enabled before allowing the host to operate the payload interpreter to read part or all of the data payload.

Thus, enablement of the payload interpreter carried by the data parcel on the host is required to read the payload.

In an embodiment, enabling the data parcel comprises altering the data parcel to include a history record to indicate that the data parcel has been enabled on the host.

In an embodiment, the method comprises conducting a check to determine that the data parcel includes a history record and that the payload interpreter is available for use.

In an embodiment, the data payload contains at least one data product. In an embodiment, the reference data may specify a data product or data products not in the data parcel.

In an embodiment, at least one data product is encrypted.

In an embodiment, the step of conducting a check further comprises checking that the data parcel is enabled on the host.

In an embodiment, the method comprises providing the reference data to the host after conducting the check, the reference data identifying the data product and including at least one condition for decryption and release of the data product, the method further comprising determining that each condition has been complied with prior to decrypting and releasing the data product.

In an embodiment, the payload interpreter is encrypted and is decrypted by the interface API by a first decrypter of the interface API.

In an embodiment, a second decrypter is decrypted by the first decrypter, and the reference data is encrypted and decrypted by the second decrypter.

In an embodiment, wherein there are a plurality of data products at least some of the reference data is presented to a user of the host in the form of an off-line shopping cart in order to allow the user to select at least one data product.

In an embodiment, the interface API is delivered with the data parcel.

In an alternative embodiment, the interface API is delivered independently of the data parcel.

In an embodiment, the off-line shopping cart is delivered with the interface API.

In an embodiment, the method comprises a step of enabling each selected data product by altering the data parcel to include a history record to indicate that the data parcel may be accessed on the host, and rendering each selected data product available for subsequent access and/or use.

The first aspect also provides an electronic data parcel for distribution of at least one data product comprising:
(a) a payload interpreter accessible by an interface API for operation by a host; and
(b) a data payload readable by the payload interpreter; and
containing at least one data product, the data parcel being configured to require the data parcel to be enabled on the host before allowing the host to operate the payload interpreter to read part or all of the payload.

In a second aspect, the invention provides a computer implemented method of monitoring release of a data product comprising:
distributing at least one data product by providing a data parcel containing at least one data product and a payload interpreter required to access at least one data product; and
altering the data parcel during a process for release of the data product to include a history record specific to the host on which the data parcel has been previously enabled, whereby if the data parcel or a further data parcel derived from the data parcel is distributed from the host to a further host after the data parcel has been enabled, the data parcel or further data parcel includes a history record of the previous host.

In an embodiment, the method comprises linking registration of at least one data product by the further host to any registration made by a previous host based on the history record.

In an embodiment, the method comprises enabling hosts to generate further data parcels comprising all or part of the original data parcel for sub-distribution.

The second aspect also provides an electronic data parcel arranged to enable release of a data product, the data parcel comprising:
a payload including a data product; and a payload interpreter required to read part or all of the payload,
the data parcel configured such that during a process for release of the data product, the data parcel is altered to include a record of the host on which the data parcel is enabled, whereby if the data parcel or a further data parcel derived from the data parcel is distributed from the host to a further host after the data parcel has been enabled, the data parcel or further data parcel includes a history record of the previous host.

Thus, embodiments of the invention provide effective electronic distribution techniques that accommodate common retail and virtual supply methods, recognise several different delivery mechanisms, support a multilevel marketing model, are applicable to peer to peer file sharing operations, and accommodates private and public broadcast and centralised server delivery.

### BRIEF DESCRIPTION OF THE DRAWINGS

A preferred embodiment of the invention will now be described in relation to the accompanying drawings in which:

FIG. 1 is an overview of the product release process of the preferred embodiment;

FIG. 2 shows further detail of the product release process;

FIG. 3 shows how the product interacts with the interface API during product runtime;

FIG. 4 shows how a product may be replicated;

FIG. 5 is a schematic diagram of the assembly and release of a data product;

FIG. 6 is a schematic diagram showing the make up of a Cabinet for delivering a data product;

FIGS. 7 to 9 are schematic diagrams showing several stages of release of a data product from a data parcel;

FIGS. 10 to 15 are schematic diagrams of distribution techniques supported by the data parcel of the preferred embodiment;

FIGS. 16 and 17 are schematic diagrams of two interpretations of what comprises a “Cabinet”;

FIG. 18 illustrates the audit trail contained in a data parcel; and

FIG. 19 is a schematic diagram of the components of a Cabinet and shows how an application accesses protected data products contained in the payload.

### DESCRIPTION OF THE PREFERRED EMBODIMENT

The preferred embodiment provides a “Versatile Digital Rights Management” (VDRM) method that can be used to control release of a data product, monitor release of the data product, assist with assembly of the data product and enforce a license to use the data product.

### DEFINITIONS

“Application” (App) refers to any self-reliant machine executable process that can be initiated by a computer user.

“Application Program interface” (API) refers to any dependent object code which relies on an “application” to be useful.

“Data product” refers to any digital product, such as music, digital information, software, files or the like. Typically, the reason for protecting the data product will be that it embodies certain intellectual property rights.

“Data parcel” has at least a “payload interpreter” and a “data payload” which contains the data product.

A “Payload interpreter” (also referred to herein as a “Cone interpreter”) is a software application configured to read the payload.

“Payload” refers to all the data contained within the data parcel that requires a payload interpreter to be read. There may be other data contained in the data parcel that is accessible in other ways. The data payload will typically include “reference data” describing the information contained within the data payload and one or more data products. The data payload may also include other information, such as conditions for release of the data product.

In the preferred embodiment, a custom application is required to access the data parcel which is referred to as an “interface” API as it provides the interface between the host computer application and the data parcel. The data parcel is referred to herein as a “Cone” when it has the payload interpreter and the data payload. The data parcel may also be supplied with the interface API in which case it is referred to as a “Cabinet” or in some contexts, as a “Runable Versatile Device” (RVD). That is, a data parcel may be supplied with the software applications and/or API's required to access it.

If an object or file is referred to as “private”, the object is protected (eg. by encryption) and if an object or file is referred to as “public” it is unprotected or no longer protected, eg. it has been decrypted previously.

“Compiled-in” refers to object code which is integral to a software application.

An “author” is any party who contributed to creation of a “data product”.

A “producer” is the party responsible for assembling any part of a data product.

An “owner” is a party who owns intellectual property rights, such as copyright, in the data product.

A “publisher” is a party responsible for packaging data products on behalf of owners for authorised delivery by one or more distributors.

A “distributor” is a party responsible for delivering data products to the markets.

A “customer” is a party to whom the data product is distributed.

A “sub-distributor” is positioned between a distributor and a customer and may also be a customer.

### Overview

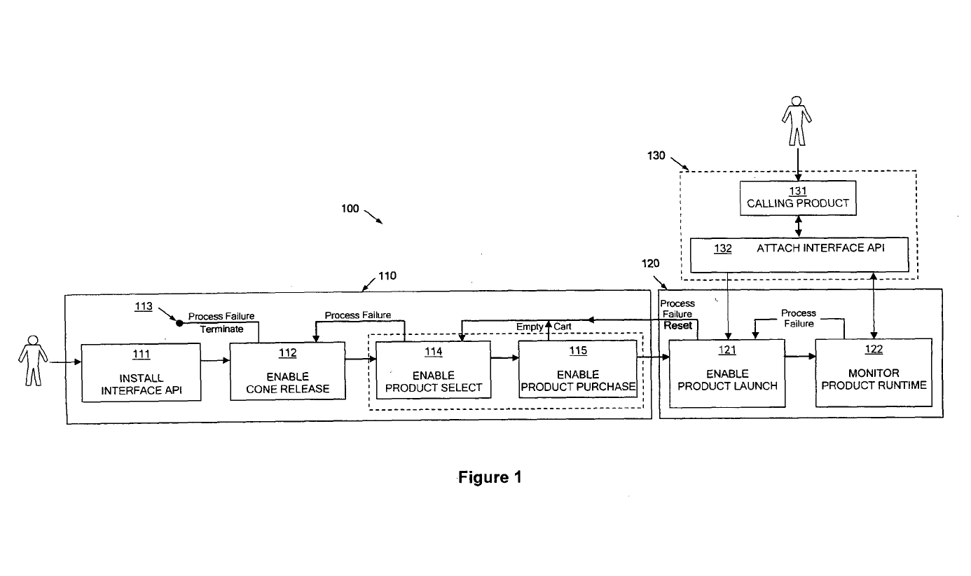

Referring to FIG. 1, there is shown an overview of the Versatile Digital Rights Management release process 100 of the embodiment. In the embodiment, the method that ensures that release of a product is controlled during an initial release process 110 and checking of the release process is enforced during each and every product use 130.

First, an interface API (together with an integrated off-line shopping cart) is installed 111 on a host computer. As explained above, the interface API can be supplied as part of the data parcel (as a Cabinet) or independently. Typically the interface API is a public object that is platform portable so that it can be run on different types of host; for example a java applet. Alternatively, the interface API is tailored to meet the specific requirements of a generic host platform, or may be comprised of both platform portable and platform specific software components. The interface API can be supplied via an Internet download or on removable media.

The next step is to enable release of the Cone 112. If the Cone release process 112 fails, there is a process failure 113 and the product release process terminates. As will be apparent from further description of the process for releasing a product, the process is designed so that there are in effect a series of building blocks that are required to be in place and if any of these are absent, the process seeks to establish them. The first of these building blocks is to seek to enable release of the data parcel or “Cone”. A process failure 113 occurs when this “foundation” building block is absent. The Cone release process will typically be platform portable as it is controlled by the installed interface API. The Cone is a private object that requires the interface API to incorporate a compatible encryption version or decryption key(s) in order to be executed. The process of Cone release results in the release of one or more product applications for launching the protected product(s) as well as public program and resource files required to support the immediate requirements of protected product launch. Following Cone release, the shopping cart gains access to information contained in the data payload sufficient only to present an overview of the payload contents.

After the Cone has been released, it is necessary to enable payload access by registering the Cone payload. Registration of a Cone results in reference data being accessible which describes in detail the available data products which are typically stored in the Cone. These can then be presented in the form of a shopping cart for user selection. If the terminology API is not included as part of the interface API, the payload reader also loads terminology into the host which enables the data to be interpreted and presented, for example, specific definitions relevant to the language and terms best suited to a given host regional environment. Conditions for release of the product, such as a price to be paid for the product and requirements to activate the product, are also loaded to the host to enable product selection 114. To allow users to select which data product or products they wish to use, the offline shopping cart provided enables product purchase 115 by presenting and overseeing selection of data products. This process 115 also involves registering a license for use of the product, and activating the product.

During an initial release 110, the process 100 will typically proceed directly to enabling product launch 121. The product launch step 121 checks that the various previous steps 112, 114 and 115 have been completed before providing access to the payload, and the products it contains, from the host. During runtime of the product, the product is monitored 122 for tampering. The data product will only be read and made available by the interface API provided the conditions for release of the Cone, registration of the Cone payload and activation of the Product have been met.

The subsequent use process 130 involves a calling product (public application) 131 (such as a music player) seeking to open the data product (such as a music file). The calling product attaches the interface API 132 and enables product launch 121. As described above, the product launch process checks that the Cone has been enabled and the payload registered on the host correctly, and that the conditions for release of the product have been met. If they have not been met, the initial release process 110 is forced.

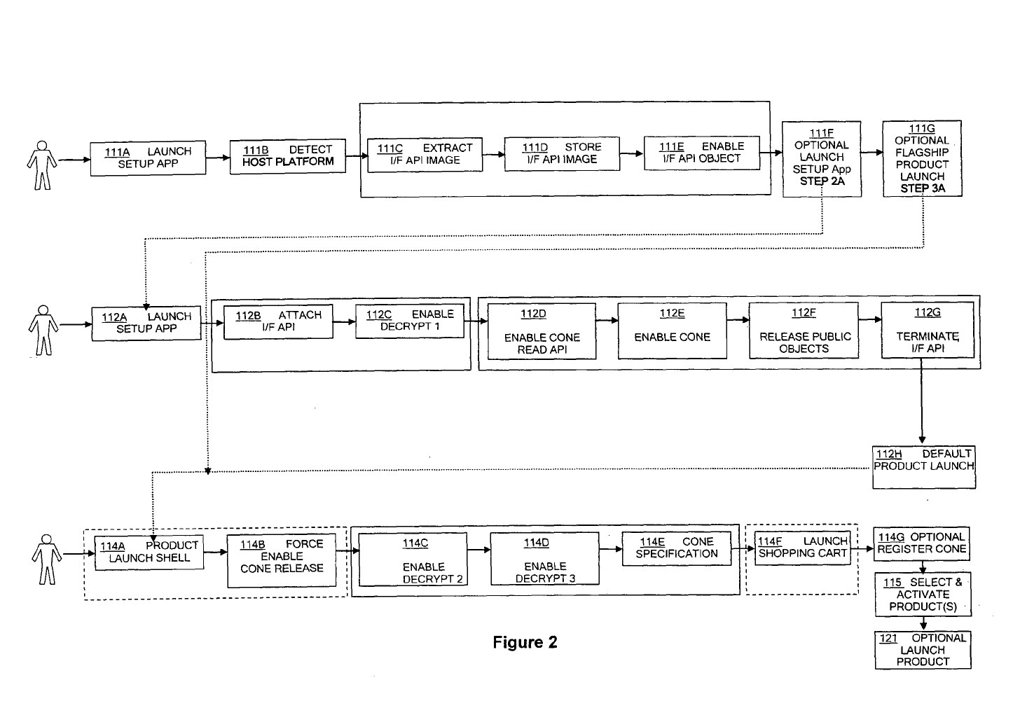

The release process is shown in more detail in FIG. 2. At step 111a, a set up application (Setup App) is launched; the set up program detects the host platform 111b, then extracts the interface API image 111 together with the shopping cart, stores it on the host 111d, and enables the interface API 111e as publicly accessible. The set up application will then proceed to a launch process 111f but might be configured (in an alternative embodiment) so that the product is launched from an included custom application 111g. In this alternative embodiment, the custom application itself may require prior registration and activation in the same way as may be mandatory for any other protected product.

Normally, the process proceeds to launch the Setup App 112a which involves attaching the interface API 112b, and enabling 112c a first level of decryption “Decrypt 1” which is a version compatible decryption service of the interface API known to the payload interpreter by version. The interface API may have a plurality of different (layered) decryption versions and keys. The interface API 112b then extracts an image of a Cone read API (a data payload interpreter) 112d. It decrypts it using Decrypt 1, and enables it as a “temporary” API object which is destroyed after use at step 112g. The Cone is then enabled 112e by adding a Child history to a history record section of the Cone. The interface API is then terminated 112g. This involves disabling temporary components and destroying temporary files. Typically on a first use the process then proceeds 112h to a default product launch. The product launch shell 114a will be either a platform specific or a platform portable product that makes a call for required program and data objects via the interface API. The interface API is designed to force enable a Cone release, at any attempted launch, if it has not occurred previously. It repeats steps 112d to 112f as necessary and checks that the Cone has a history record specifying it is a child, and that the Cone has been enabled. If not it repeats steps 112e and/or 112f as necessary.

A further level of encryption, “Decrypt 2”, is employed by extracting and decrypting (using Decrypt 1) the program image or key(s) required to enable Decrypt 2 which subsequently decrypts the Cone specification 114e and, when requested, protected program and data objects. The reference data may also be optionally encrypted with a third party encryption service or key(s) “Decrypt 3” 114d. The cone specification 114e is decrypted using 114c and optionally 114d. This provides the base of reference data used to launch a shopping cart 114f. The reference data specifies all data products available when a Cone is released and the conditions (if any) for their release. When launched at 114f, the shopping cart can “present” an outline of the contents of the Cone and the broad conditions of its use. In order to proceed to “select” and activate any data product the Cone contains, at least provisional off-line registration 114g of the Cone payload must occur unless Cone payload registration is suppressed under Cone release rules. Once complete, Cone payload enablement and registration allows the user to select 115 what products they wish to obtain from the set of products available when the Cone is accessed and determine whether they are prepared to comply with the detailed relevant conditions, which may include the purchase, payment, delivery, registration and activation of the product. Typically, the available products will be stored in the Cone but the reference data may also be a catalogue for data products stored elsewhere. Depending on the conditions for product release and whether the user wants to launch the product, the process may then proceed through a number of additional steps including permanent registration of the Cone payload (“License”) on-line or off-line, activation of the products 115 and launch of one user nominated product 121.

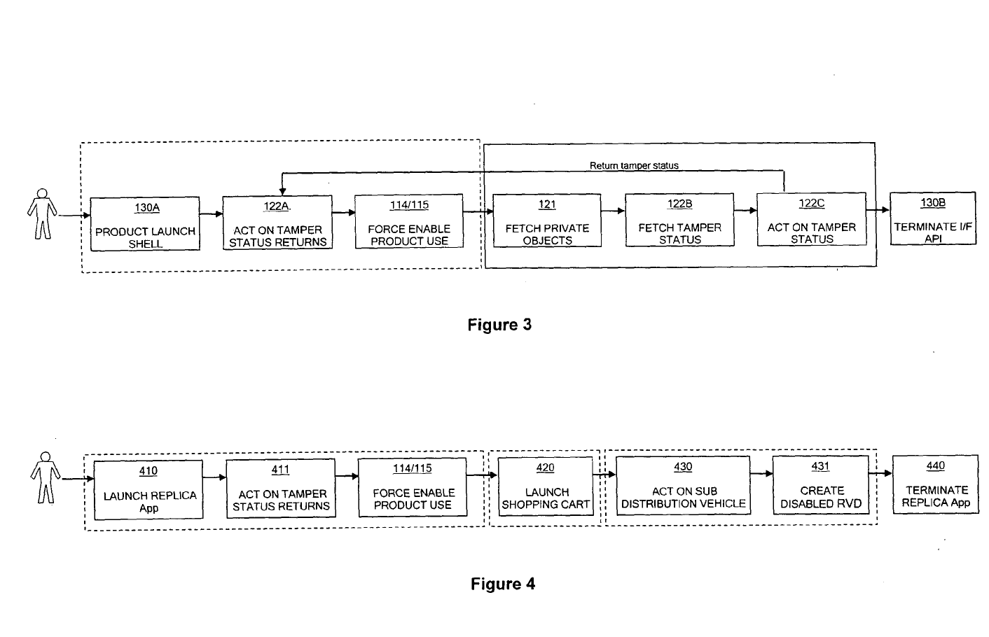

FIG. 3, shows the process used for product launch and monitoring throughout runtime. At step 130a a product launch shell is activated: this may set up a process for acting on a tamper status. Steps 114/115 involve repeating steps 114b to 114e as necessary, to determine whether the Cone payload license has been registered at step 114g, whether the product has been activated at step 115 and if not repeating the enablement, registration and activation processes commencing at 114B.

At step 121 the private objects are fetched and can be accessed by the product launch shell 130a which can also request and act on (if desired) static and dynamic tamper statuses throughout data product runtime. The interface API itself may be configured to act on a tamper status 122c. At step 130b, the interface API is terminated, the interface API having been launched by the product application shell.

FIG. 4, shows in general terms a sub-distribution method. A further program known as Replica App 410 is provided which is launched and configured to itself act on tamper status returns. After attaching the interface API, Replica App may force enable Cone release 112, may then force enable Cone registration 114 if the Cone license has not been registered, and further force activate the product 115. Then the shopping cart is launched 420 to allow selection of the product to be sub-distributed. A replica is then produced in accordance with one of a number of possibilities at step 430 including a Personal copy, a Single copy, a Portable copy, a Family copy, a Bulk copy or a Multi copy as will be explained in more detail below. At step 431a data parcel is created which may be supplied as a Cone or as part of a Cabinet to another user. When the program Replica is used to replicate all or part of a data parcel, the data parcel will contain a history record of the host on which the Cone is created. At step 440, the program Replica and the interface API are both terminated.

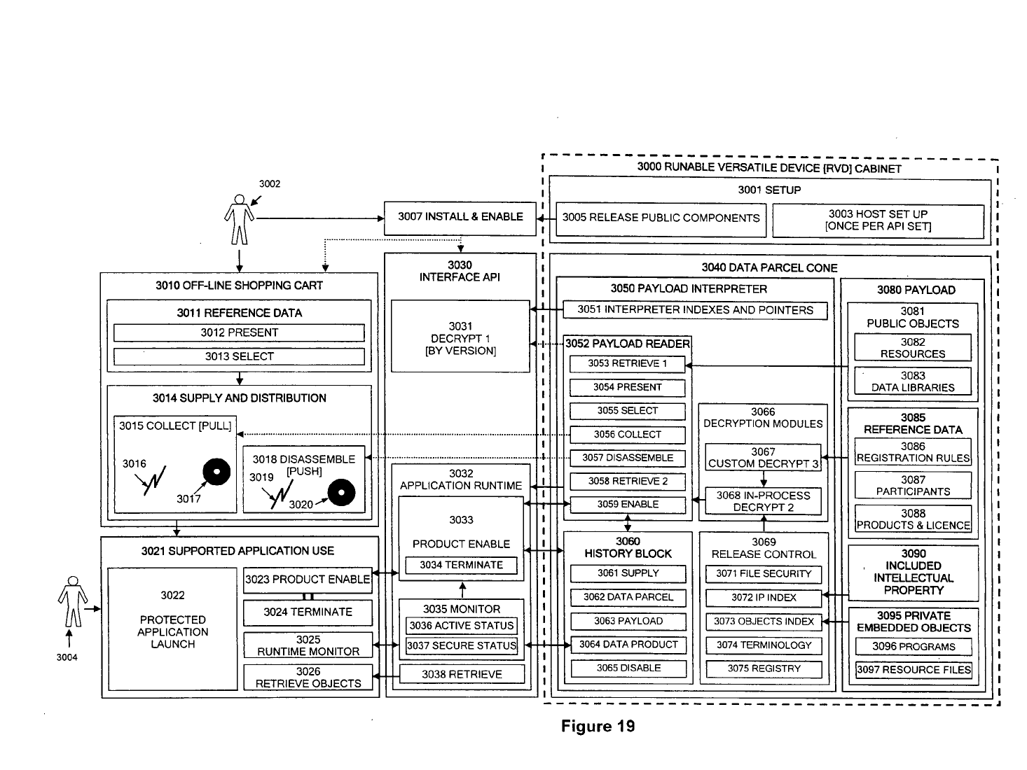

Referring to FIG. 19, there is shown a schematic diagram and the components of a Cabinet 3000 known as a Runable Versatile Device. The setup components that are released from a cabinet enable interaction with the data parcel.

Thus, the supply to a consumer may be:
(i) a self-extracting executable file shown as a “set up” 3001, or
(ii) a configurable data file shown as a “Data Parcel” or a “Cone” 3040, or
(iii) both a “set up” and a data parcel as a “Cabinet” (RVD).

The purpose of delivering a cabinet is to perform host platform specific Set Up 3003 by releasing public platform portable or platform specific software components 3005 and, subsequently, installing and enabling 3007 prerequisite general purpose components, namely:
(i) an Off-Line Shopping Cart (“OSC”) 3010 module, and
(ii) a compatible interface API (“IFS”) 3030 module which may incorporate a compiled-in OSC; and
(iii) any software components, other than those embedded in the data parcel, on which IFS and OSC operations depend.

The precise configuration of a set up arises after tailoring its contents so that the set up is suitable for the purposes of the host platform operator be they:
(i) a licensed distributor,
(ii) a retail outlet,
(iii) a peer to peer file share operator,
(iv) a third party who seeks to become a sub distributor, or
(v) a consuming end user.

As explained later, the purpose of the shopping cart and interface API modules is to provide homogeneous cross-platform access to the Payload Interpreter 3050 and Payload 3080.

The payload interpreter is a configurable combination of software components and data designed to provide information about, and release of, the payload. The payload interpreter software has:
(i) a Payload Reader 3052 which provides the focal point for support of implemented payload release methods,
(ii) A decryption API service image or key(s) Decrypt 2 3068 which itself requires decryption by the payload interpreter using Decrypt 1 3031,
(iii) a language processing API program image, optionally encrypted using Decrypt 2, which handles interpretation of presented Terminology 3074, and
(iv) a registration API program image 3075, optionally encrypted using Decrypt 2, which manages all off-line and on-line license registration and product activation sessions if these are to be enforced according to the registration rules.

In addition, the payload interpreter software components may include:
(v) a decryption API service image or key(s) Custom Decrypt 3 3067 which itself requires decryption by the payload reader using Decrypt 2. When included, Decrypt 3 provides the final stage of encryption and the first stage of decryption of the reference data. Decrypt 3 3067 will typically be provided by one participant owner third party.

When the OSC or protected product runtime Terminates 3024, termination of the interface API 3034 and the “referenced” payload reader 3052 occurs automatically as a result. Accordingly, this event also triggers disablement and destruction of the temporary payload interpreter supporting API object references and file images.

When started in response to OSC or Protected Application Launch 3022, the payload interpreter gains access to the indexes and pointers 3051 required to:
(i) Enable access to the File Security 3071 sector,
(ii) Enable access to both the Included Intellectual Property Index 3072 and the Embedded Objects Index 3073,
(iii) Enable access to the History Block 3060,
(iv) Enable access to the Registration Rules 3086,
(v) Extract a Payload Reader 3052 API from the data parcel, and
(vi) Enable the payload.

Subsequent access to, and use of, the payload reader is subject to its enablement status which is determined by examining the history block and, specifically, the Data Parcel records 3062 and Payload records 3063 the block contains. If not already active, the payload interpreter will automatically seek to perform enablement to the payload level which involves Cone enablement and on-line, off-line, or transparent license registration unless license registration is suppressed as defined in the registration rules.

The first stage of enablement requires a “Child” 3062 history record to be inserted into the data parcel to allow release of priority Public Objects 3081. Priority public objects are software component and data Resources 3082 which facilitate subsequent stages of data parcel release and those which allow the immediate release of protected product launch shells together with other priority help, information and resource files. Any “demonstration” product launch shells and associated resource files are also made available on completion of the first stage of data parcel enablement.

Prior to restricted information contained in the Reference Data 3085 being made available, a “Register” 3063 history record must be inserted into the data parcel so that access to some protected parts of the payload is enabled. It is only following this stage of enablement that full functionality of the OSC becomes available, and options to purchase and/or operate protected data products contained in the payload becomes possible.

Any data product delivered as part of a data parcel payload in the form of Included Intellectual Property 3090 or Private Embedded Objects 3095, including Programs 3096 and/or Resource Files 3097, is “disabled” unless it belongs to the “demonstration” category mentioned earlier.

At any time a Protected Application Launch 3022 implies an attempt to access or use a disabled protected data product via the interface API 3033 and payload reader 3059, the Registration Rules 3086 which govern release of that data product are invoked and enablement will be subject to on-line, off-line or transparent activation unless registration of the data product is to be suppressed. When activation of each data product is completed according to the registration rules for a given host platform, an “Activate” 3064 history record is inserted into the data parcel.

The purpose of the payload reader 3052 is to:
(i) Act on requests from the IFS to Product Enable 3033 or Terminate 3034,
(ii) Check that all stages of Data Parcel 3062, Payload 3063 and Data Product 3064 enablement have been satisfied each time a protected product launch shell is started,
(iii) Provide the interface API 3030 with the information required in order to Monitor 3035 the activation status 3036 and tamper status 3037 throughout protected application runtime. Depending on the design of the executing data product and/or its launch shell, a tailored Runtime Monitor 3025 can act on status return flags received from the IFS following randomly timed or event based requests for rechecks, and
(iv) Retrieve 3058, manage and monitor Private Embedded Objects 3095 when a request to Retrieve 3038 is received from the IFS following a synonymous Retrieve Objects 3026 request being issued by the Protected Application Launch 3022 shell.

Additionally, in the event that any check that all stages of Data Parcel 3062, Payload 3063 and Data Product 3064 enablement are complete remains unsatisfied, and at the option of the product launch shell, the payload reader will commence to process all outstanding enablement stages which continue to prevent activation of the launched application, including action to:
(v) Present 3054 available Data Parcel overview and usage conditions information for use by the OSC,
(vi) Act on Select 3055 requests from the OSC to provide further details of Participants 3087 and available products 3088 contained in the Reference Data 3085 or to enable demonstration products,
(vii) Act on Collect 3056 requests from the OSC which entail retrieving additional data products or objects from the Internet on-line,
(viii) Act on requests from the OSC, overseen by the Replica App, to Disassemble 3057 a Cone or RVD to create an accessible subset of that Cone or RVD,
(ix) Initiate and oversee license registration and product activation requests, and
(x) Retrieve 3053 and store data product specific Public Object 3081 Resources 3082 and Data Libraries 3083, unless the data libraries are earmarked as not to be copied from removable media.

The interface API provides seamless host device independent connection between a protected application launch shell and the resources required in order to operate a data product in accordance with its design and release conditions.

The additional purpose of the IFS is to simplify communication with the payload interpreter by accessing all its functionality using three public processes:
(i) Product Enable 3033 in response to attempted launch of a protected application,
(ii) Retrieve 3038 program and data objects on request during runtime, and
(iii) Terminate 3034 which performs platform specific clean-up operations.

The IFS can also be asked to report on data product runtime security using two public status returns:
(iv) Active Status 3036 which reports the continuing status of Data Product 3064 enablement, and
(v) Secure Status 3037 which reports dynamically the tamper status in regard to protected data products and related objects.

As mentioned previously, Decrypt 1 3031 is version based in order to protect the integrity of payload release by linking any data parcel to a specific range of interface API's.

Protected Application Launch 3022 is the host platform specific process that a consumer 3004 uses to initiate each attempt to access and use any associated data product contained in a data parcel Payload 3080.

In order to make use of a data parcel, a supported application “converses” with the data parcel using the IFS. Accordingly, understanding the specific design requirements of a product launch shell which can make full use of the functionality of a data parcel is predicated on knowing how to access and operate an IFS.

The off-line shopping cart is used to control the collection and distribution of data products contained in one or more RVD data parcels.

Since the payload itself may contain one or more data parcels, the OSC also caters for processing the information and data products contained in a composite RVD comprised of a treed structure designed to deliver a range of disparate or related data products.

FIG. 19 shows the OSC as distinct from the IFS so as to depict the placement of its function in relation to its current user 3002 and to link its operational flow through to supported application use. In fact, as mentioned previously, the OSC is delivered and installed either as compiled-in to the IFS or as an API the IFS alone references.

The principal functions of the OSC are to:
(i) Facilitate ease of off-line data product take up and enablement, and
(ii) Streamline techniques available to propagate part or all of the contents of an RVD or any constituent Cone.

In order to provide the functionality described, the Supply and Distribution 3014 processes provided relate to:
(i) Using the process shown as Collect 3015 to “Pull” data products into a computer host by sourcing data products available Internet On-Line 3016 or supplied as removable media 3017, or
(ii) Using the process shown as Disassemble 3018 to “Push” data products by creating a new RVD or Cone on removable media 3020 or making a new Cone or RVD available for Download or Email On-Line 3019. In certain delivery models, consumers receive an incentive to apply the push process.

Receipt of payment is typically not a condition of either collection or disassembly of a Cone or RVD (Cabinet) and, although the OSC always operates off-line at the consumer host, distribution web sites mirror OSC functionality on-line so that “Pull” processes, be they on-line, off-line or retail, appear homogeneous from the consumer perspective.

Further, regardless of whether the process in question is pull or push, the OSC provides a standard facility designed to achieve the required result. Because the orientation of shopping cart functionality is to simplify consumer take up, the focus of its operation is on:
(i) Quick preparation of a provisional tax invoice, and
(ii) Providing details of data volumes required to be moved and/or stored.

Accordingly, the Reference Data 3011 is requested from the payload reader which enables Presentation 3012 of relevant information to facilitate Selection 3013 of the data products required. Part of the selection process involves rendering demonstrations and providing further reference data details which are designated as public.

As described previously, the payload reader processes requests from the OSC (ISF) to both Collect 3056 and Disassemble 3057. Whilst collection requests are related to aggregation of data products on a host for later enablement and activation, disassembly requests belong to various categories of sub distribution, including:
(i) Provide a full or partial enabled replica of the subject RVD or Cone as revenue neutral (“Personal”),
(ii) Provide a full or partial disabled replica of the subject RVD or Cone as revenue neutral (“Single”),
(iii) Disable 3065 for free reactivation of a copy of the RVD on another host (“Portable”),
(iv) Insert a “Sibling” Supply [3061] record for ready to activate (free) on another host (“Family”),
(v) Insert a “Sibling” supply record for ready to activate (prepaid) on another host (“Bulk”),
(vi) Insert a “Scion” supply record to provide a full or partial disabled replica of the subject RVD as reproducible incentive based (“Multi”)

Prior to the Cone or Cabinet being distributed, the Cone technology supports a structured assembly method to allow authors, owners, producers, publishers and distributors to cooperate to produce for distribution.

The principal stages of Cone evolution are named by the stage of development:

A Project Cone contains the definitions of the participant owners, producers and the publisher together with the specification of intellectual property to be included. The Project Cone may or may not include some data products.
A Market Model Cone adds details of participant distributors, customer profiles, protected products and default pricing. Included data product references are always present prior to completion of a model Cone.
A License Cone adds specific license, launch and registration conditions to each protected data product definition and allows for customisation of product pricing.
A Product Release Cone adds public and private (protected) program and data objects.
A Product Release RVD (Cabinet) is the Product Release Cone packaged as a self-extracting application file including the Setup App and IFS (with OSC).
A Distribution Cone or RVD is a copy of the Product Release Cone or RVD but includes a unique publisher Parent history record.
A Delivered Cone or RVD is a copy of the Distribution Cone or RVD but includes a unique distributor or retailer Supply history record

Cones on the Consumer Host may be one of:
Delivered Cone or RVD (Disabled),
Enabled Cone (Data Parcel enabled),
Licensed Cone (Data Payload enabled),
Activated Cone (Data Product(s) enabled), and
Reconstituted Cone or RVD prior to sub distribution.

### Supply Chain Management

Application of Cone technology supports secure publication, supply and release (“Consumer Take-up and Propagation”) of digital intellectual property issued in the form of software, information or entertainment content. Overall control of all Cone assembly processes is the responsibility of the publisher who proceeds stepwise according to a strictly prescribed methodology.

In order to provide warranted resistance to misuse, abuse, simulation, malicious damage and fraud, adoption of appropriate levels of encoding and encryption are employed, both during the publication process and later when the Cone is released for consumer take-up and propagation.

In particular, encryption services available are generally layered and version based and may be proprietary, and/or public and/or industry standard “Public Key Infrastructure” (PKI) based. Different encryption techniques and keys are applied in any Cone release so they differ from those applied in any other so as to render any breach of security as “one-off”.

Protection provided by encryption techniques is supplemented by employing internet login and password procedures (“access keys”).

During the publication phase described later, movement of Cones during construction will typically be “virtual” in that participants in Cone creation will perform an internet login to gain the specific publication access they require in order to edit their details and fulfil their responsibilities in the assembly process. In some cases, however, the Cone may be passed physically between publishing participants requiring that the Cone be shipped as an RVD (Cabinet) comprising not only the subject Cone, but also necessary Cone creation application tools.

On virtual or actual receipt of a Cabinet containing the subject Cone, any participant has the ability to customise their access key(s) so as to protect their contribution to assembly from accidental or intentional abuse by other parties.

Cone publication occurs in four clearly defined forward dependent stages where each subsequent stage may create multiple Cones based on the completed Cone from the immediate previous stage. Project Cone creation is the first stage in publication and each subsequent stage locks the immediate previous stage and introduces a set of new participants related to the function of the Cone at that new level.

The Cone publication phase occurs according to a strict chronology as:
Project Cone
Owner(s)
Producer(s)
Publisher (one only)
Participant access keys (editable)
Market Model Cone
Distributor(s)
Distributor access keys (editable)
Customer Profile(s)
Products available (may include Product Release Cones or Cabinets)
Product Pricing (default)
Payment Methods
License Cone
One to one Distributor to Customer relationship
Cone enablement conditions
Payload registration conditions
Selected included Products and, per product:
   License Type
   Delivery Vehicle
   Custom Pricing
   Commencement and Expiration dates
   Authorised Access Counts
   Activation conditions
Product Release Cone (RVD)
One selected license
Included private and public program, data and data library objects

Typically, Cone publishing practice may involve a single Project Cone being used to generate a plurality of Market Model Cones which may each then be used as the source for a plurality of License Cones which each in turn provide the basis for multiple Release Cones and RVD's.

Initially, the publisher creates a “Project” which includes skeletal definitions of the participant owners, producers and the publisher. The publisher allocates a security keys to itself and each of the other participants for the purpose of providing access to run the publishing application tools, hereafter referred to as “ConeStructor”. As described previously, the reason for use of these access codes is to restrict each participant solely to areas of their responsibility and, conversely, to prevent unauthorised access to their area by other participants.

The principal task of each producer is to include the property for which they are responsible. This requires that the producer know the included intellectual property access keys prescribed by the relevant owner at the time included property was defined. A producer is able to introduce or remove (or replace) objects for which they are responsible by running the ConeStructor application, entering the correct producer access key, providing data product group and component property keys or product passwords and browsing to the physical computer files which contain the relevant property.

Whereas inclusion of data product components (included intellectual property) can be scheduled at any time after the definitions have been created by the owner of that property, included product objects cannot be introduced until the dependent product has been defined at the Market Model creation stage.

Private data product objects are not introduced until the license creation stage when their inclusion becomes required in line with the contents of the Cone's catalogue.

During creation of a Project Cone any one predetermined owner may optionally include a Custom Encryption service image and/or key(s) 114D (i.e. Decrypt 3).

The publisher is responsible for the creation of Market Model definitions based on completed Project Cones. The model creation process involves definition of distributor participants together with sub distribution rules other than those already prescribed by owners, actual or pro form a customer profiles, and included product definitions and default product pricing.

Sub definitions also tied to the delivery model include product sales and support definitions, regional distribution rights, available payment methods, privacy statements and customer based terminology.

The publisher is responsible for the license creation process which involves selection of a single distributor linked to a specific customer profile to lay the foundation for later creation of one or more product releases. Sub definitions also tied to the license include the Cone first and last available dates, selection of the products to be included in the release, customised licence types and launch conditions for each selected product, license registration rules and the activation conditions associated with each product. Delivery vehicles and use by dates of products are also defined at the license creation stage.

The publisher controlled process of product release involves both automatic and manual inclusion (by a producer and/or the publisher) of public and selected private program and data objects required in order to make included protected products operable in the manner contemplated by their owners. When the product release process is complete a unique Release history record is included.

Throughout all stages of Cone assembly, the Cone history block is sequentially appended to record the order and nature of the events which have contributed to its contents as:
Project record and Owner, Producer or Publisher action
Model record and Publisher or Distributor action
License record and Publisher or Producer action
Release record and Publisher or Producer action
Parent record and Publisher action

### Consumer Take-Up and Propagation

The Web Service Monitor (WSM) is the API component that supervises internet traffic, records and passes remote requests using the Distribution Management System (DMS), and acts on instructions received from the DMS. The WSM is the hub that controls all Publisher eCommerce activities.

The OSC is the application which is the standard presentation off-line Cone browser (mirrored on-line at distributor web sites) that enables informed selection of required products by a consumer, prepares shopping carts for presentation at the check out, and draft or final tax invoices. The OSC also renders enabled help and approved advertising content contained in the RVD.

The distributor DMS receives and acts on requests from the WSM, communicates requests to (and receives instructions and files from) the publisher, and provides instructions to the WSM. Activities handled include:
Monitor distributor web site activity,
Record and report web site visits,
Provide Cone or RVD Supply histories,
Oversee and record downloads,
Issue license registration keys,
Receive and record on-line payments, and
Issue product activation keys.

The Publication Explorer (PBX) provides access to visual reports and exported data available from the DMS and the on-line interface with the distributor.

Whilst responsibility for overseeing (as intermediary) the issue of product release download Cones and media RVD's resides with an appointed distributor, replicas of these objects cannot be delivered or enabled without intervention of the publisher when license registration and product activation, if mandatory, occur later.

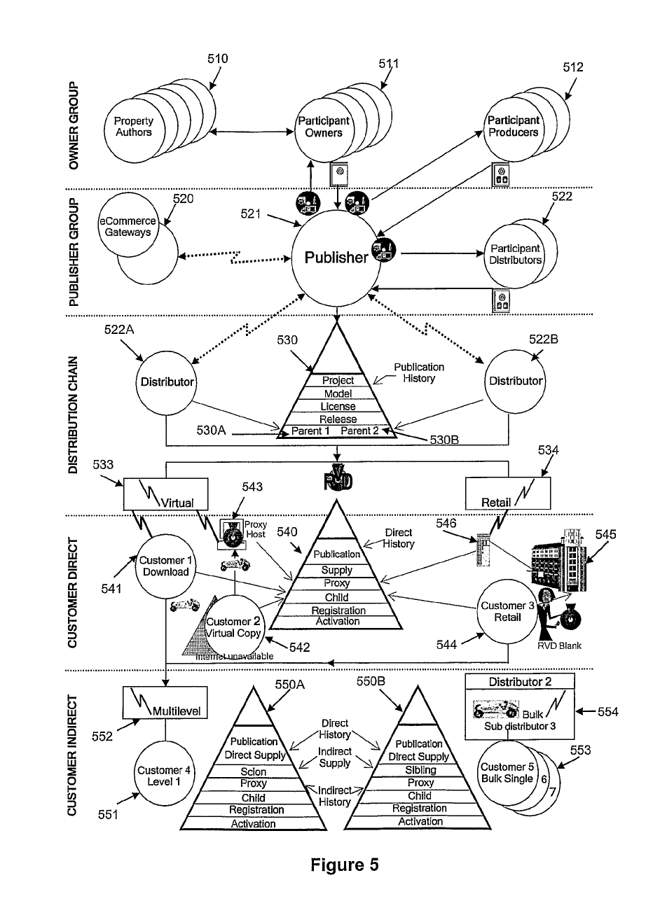

Referring to FIG. 5 there is shown an example of five original authors 510 who have assigned the copyright in their intellectual property to four owners 511 who in turn use three participant producers 512 to contribute to a product release which will be supplied by two authorised distributors 522. In this case, the two “virtual” Product Release Cones shown as RVD 530 provided to the distributors are only distinguishable by the difference in the Parent history record that each includes, and each distributor is authorised to deliver using both Internet and retail outlets. Hence a single virtual Cone with two separate Parent records 530A, 530B is shown in FIG. 5.

The audit trail the completed (deliverable) release Cone contains includes:
A set of Project records which reflect the history of owner, producer and publisher activity,
A set of Model records which reflect the subsequent publisher and distributor activity,
A set of License records which reflect the publisher controlled license creation activity and producer activity if that occurred,
A single Product Release record, and
A single distributor related Parent record

FIG. 5 shows the role played by the publisher 521 both during the Cone assembly process and in overseeing product delivery, activation and collection of payments. In this latter regard, the method of distribution shown provides for two unrelated secure eCommerce gateways 520 which, together with other product take up processes, are discussed later under the subject of Cone release.

FIG. 5 also shows the two generic types of outlet; viz. Virtual 533 and Retail 534, and two distinct distribution methods; viz. Direct and Indirect. Within these classes of distribution, product delivery to five different kinds of customer profile are examined and discussed including direct on-line, retail sale, registration by proxy, and indirect multilevel and bulk distribution vehicles.

Regardless of the outlet, method or vehicle used, the delivery of an RVD (as shown in FIG. 5) or Cone must be authorised by the publisher on every occasion a successful request for Supply is received directly from an on-line customer or retail outlet via the distributor and, under any scenario, authorisation is signified by the inclusion of a unique Supply history record being contained in the delivered data parcel.

Whilst exhibiting clearly different needs, the three direct customers shown in FIG. 5 receive, enable and activate delivered RVD's in quite similar ways as summarised in Table 1.

TABLE 1

| Action | Customer 1 | Customer 2 | Customer 3 |
|---|---|---|---|
| Source RVD | Download | Virtual copy of | Retail Replica |
| | | Customer 1 download | |
| Outlet | Virtual | Replica by hand | Retail |
| Method | Direct | Direct | Direct |
| Vehicle | <Replica Personal, Single, Portable, Family or Multi> | | |
| Included History | | | |
| Publication | Product release | Product release | Product release |
| Parent | Distributor 1 | Distributor 1 | Distributor 2 |
| Supply | Prior to download | Copy of Customer 1 | Replica enablement by |
| | | | Retailer on-line |
| Child | Customer 1 host history | Customer 2 host history | Customer 3 host |
| | | | history |
| | on Cone enablement | on Cone enablement | supplied on RVD blank |
| Proxy | Not required | Proxy host history | Retail server history |
| Register | On-line direct | Proxy host on-line | Retail server on-line |
| Activate | On-line direct | Proxy host on-line | Retail server on-line |

And, if the Replica Portable vehicle is enabled

| | | | |
|---|---|---|---|
| Deactivate | On-line direct | Not available | On-line direct |
| ReActivate | On-line direct | Not available | On-line direct |

Or, if the Replica Family vehicle is enabled

| | | | |
|---|---|---|---|
| Family | On-line direct | Proxy host on-line | On-line direct |

Customer 1 541 uses an internet download process to obtain directly a virtual replica of an RVD which includes a unique Supply record and, with or without enabling and activating product use, hands a further copy of the RVD to Customer 2 542. In the case shown, Customer 1 is internet connected whilst Customer 2 is not. Accordingly, whilst Customer 1 is able to perform license enablement and subsequent on-line product activation processes listed in the table simply, Customer 2 performs a three stage process to effect the same result.

First, Customer 2 542 uploads a copy of the RVD to the intended product host device so that the included Cone can be enabled by addition of a Child record, performs provisional payload registration off-line, activates the enabled OSC, selects the products suited to Customer 2 542, and creates a new RVD under the control of the Replica application.

The Customer 2 RVD subset so created then contains:
All Cone history up to and including Supply,
Valid provisional host device Child history, and
Details of the contents of a Shopping Cart

Next, Customer 2 returns to Customer 1, or any alternative internet connected device able to act as proxy host 543, uploads the new RVD, registers the Cone license, activates and pays for selected products and creates a ‘ready-to-run’ RVD. Finally, Customer 2 returns to the intended product host device and runs the RVD, thereby performing a process which transparently registers and activates all authorised products, and launches the default ‘flagship’ product application shell.

In summary, the similarity between the modified Customer 1 and 2 runtime licenses is a common history ending with the same Supply record. The difference between the two is apparent in all subsequent enablement, registration and activation records, and because the Customer 2 license includes a Proxy record whilst the Customer 1 license does not. These are all recorded in the Cone 540.

The action taken by retail Customer 3 who uses the Retail method to convert an RVD blank into a registered and activated ready-to-run product RVD is intentionally very similar to that performed by Customer 2. Whilst Customer 3 likely has a retail catalogue they, as distinct from Customers 1 and 2, have no immediate access to an RVD containing products listed in that catalogue and, for whatever good reason, wish to select and purchase products at a shop 545. Accordingly, in the case of Customer 3, the responsibility for providing source RVD's, shopping cart facilities, counter checkout and provision of the ready-to-run RVD falls to the retailer who is rewarded in the usual way; viz. retail margin.

At checkout, the retailer (as in the past) determines the amount of the invoice to be paid by the customer following receipt of the retailer on account invoice and completion of provisional purchase from the distributor. When the cash, credit or on account transaction is completed with the customer at the counter, a Supply record is requested from the publisher (via the distributor), the transaction completed and the ready-to-run RVD generated.

Indirect sub distribution shown in FIG. 5 can optionally be enabled in two distinct ways using alternative delivery vehicles; viz. Replica Multi or Replica Bulk. It is not recommended that these two vehicles be used to deliver the same product release in the same market as conflicts may occur in the sub distribution chain. Hence, whilst FIG. 5 depicts both vehicles applied to the same product release in essentially the same market place, this would not occur by design in practice. These two indirect delivery methods are summarised in Table 2.

TABLE 2

| Action | Customer 4 | Customer 5 |
|---|---|---|
| Source RVD | Customer 1 download | Bulk sub distributor |
| | | download |
| Outlet | Virtual | Virtual or removable |
| | | Media Replica |
| Method | Indirect | Indirect |
| Vehicle | Replica Multi | Replica Bulk |
| Included History | Customer 1 | Distributor 1 |
| | Scion | Sibling |
| Further Replication | Scion | Reverts to original form |

The essential difference between the vehicles is that Multi 552 seeks to propagate Scions through the market and to reward participant customers in the chain, whereas Bulk seeks to provide quantity discounts to one customer 554 who delivers a prepaid number of Siblings to others. The recorded RVD history shows the nature of the sub-distribution as belonging to one of these classes as distinct from an RVD replication which is a simple copy of a base level Replica Single vehicle. Indeed, Siblings issued using Bulk replication themselves become a Personal, Single or Portable license by definition, and the cloning of these delivery vehicles to form equivalent “Pushed” licenses is always encouraged. Customer 4 551 and Customer 5 553 receive an RVD and inherit sub distribution rights according to Table 2.

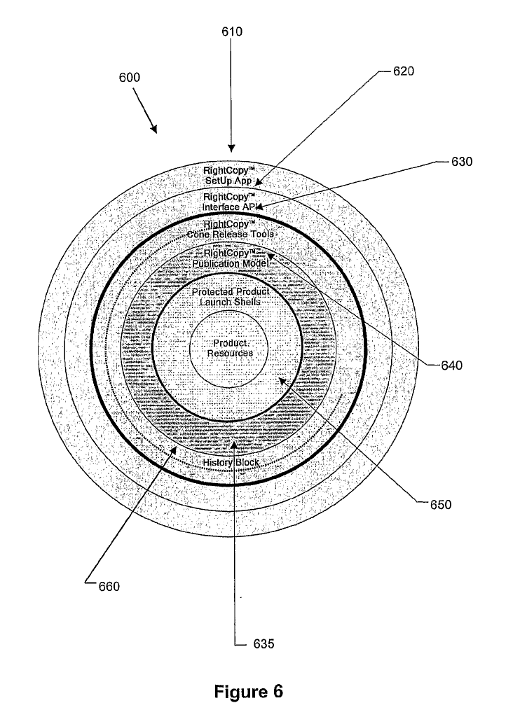

FIGS. 6 to 9 provide a further view of RVD (Cabinet) construction and Cone release. These views highlight the ‘onion-like’ nature of the structure of the objects.

As shown in FIG. 6, from outside inwards, the layers included in the unreleased RVD 600 are:
An executable outer shell, setup App 610
interface API 620 and integrated or free standing OSC, and

The included unreleased Cone 660 comprising:
Cone release tools 630,
Publication model 640,
Protected product launch shells 650, and
Protected product resources 660.

Execution of the RVD shown in FIG. 6 has the affect of:
Stripping Setup App and interface API 620 (with OSC) from the leading portion of the physical file,
Permanent storage and enablement of the Setup program for subsequent reuse, and
Storage and enablement of the interface API 620 for on-going use at each protected product launch.

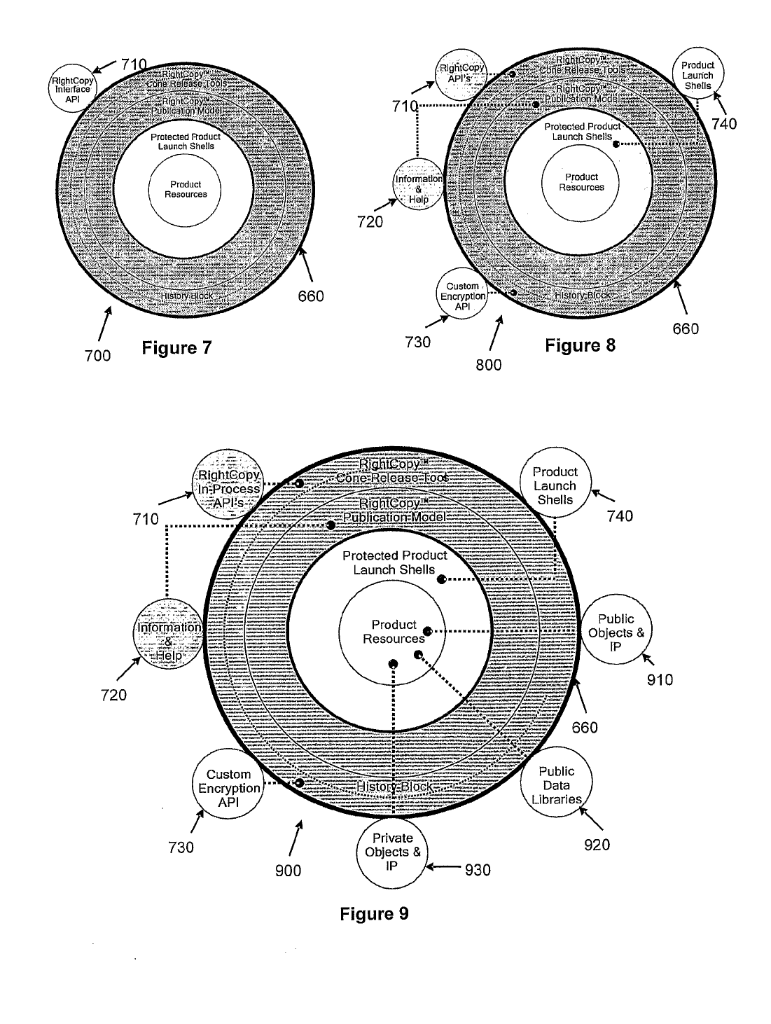

The outcome of performing the RVD release process is to isolate (on writeable media) parts of the Cone which is the subject of the product release, and the resulting intermediate phase 700 is shown in FIG. 7 with interface API 710 illustrated as available outside the Cone 660.

The next process to be performed; viz. enabling the included Cone, is illustrated as the transition from the state 700 shown in FIG. 7 to the state 800 of FIG. 8. The purpose of this phase is to:
Identify a permanent host for the Cone 660 by inclusion of a Child record,
Release an overview of the Cone contents and conditions of use 720 (“The License”),
Enable demonstration product runtime,
Enable the optional Custom Encryption 730, and
Release protected product launch shells 740.

The final action involved in RVD and included Cone release is initiated by default immediately on termination of Setup App runtime, or whenever an inactive product launch shell is executed from the desktop. The phase encompasses all processes required in order to register a Cone license, and to select and activate one or more protected products through application of the OSC.

For each product activated during the final stages of product release:
Detailed information for use by a fully operational OSC is released,
Relevant public objects 910 and data products are released from the Cone and stored in accessible form on the host device,
Public data libraries 920 on which the products depend are released and permanently stored unless product release conditions restrict access to the delivered removable media,
Supply, Register, Activate and other history is embedded in the audit trail, and
Access to private objects and the data product 930 is enabled.

The elegance of the design of the Cone, and its uniqueness in the arena of protected electronic data distribution, is best illustrated by examining briefly some of the ways in which it can be applied.

First, because the Cone file system is a ‘database’ containing all the programs and data required in order to make a third party product accessible and useable, the detail of its design and implementation can change over time as new innovations or requirements arise. Not only does this give enormous flexibility in terms of the features a Cone may include, but also leaves unlimited room for change in the security and protection systems used in any given Cone model.

Second, the Cone does not seek to compete with existing technologies and methods used to manage rights, but instead complement them by enabling a new layer of features to be added without any other change to current delivery methods.

Thirdly, in the case of protected music content, the system checks that material submitted for playback is licensed. This check is in contrast to existing systems that will in most cases render unauthorised content on request whether ‘playback’ is performed on a home entertainment system, at the desktop or using personal entertainment devices such as the Zune or iPod.

### Further Details of Distribution Vehicles

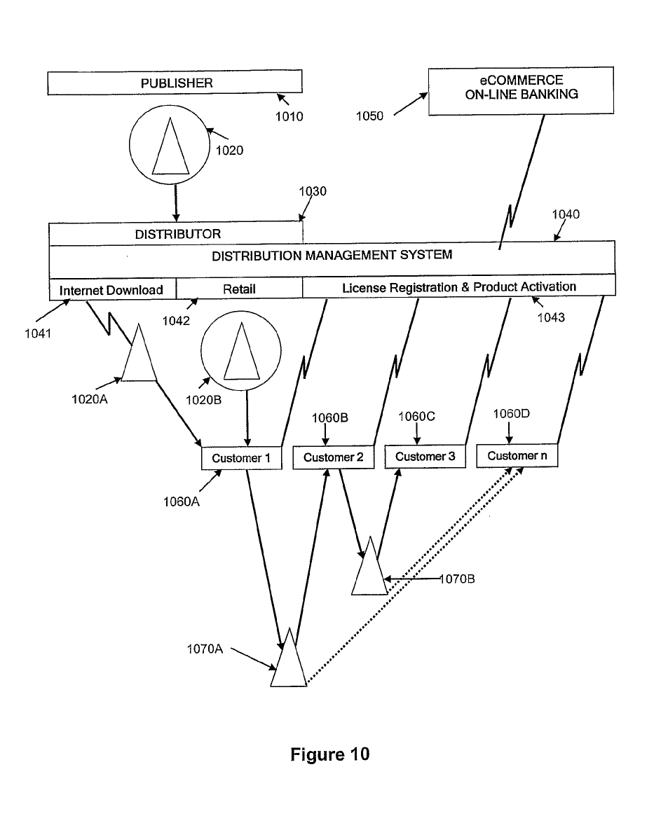

FIGS. 10 to 15 contain further details of different delivery mechanisms. In each of FIGS. 10 to 15, the distributor Distribution Management System (DMS) 1040 shown represents an integrated subset of the publisher 1010 DMS, and cannot perform any activity described below without prior action being taken by the publisher DMS.

FIG. 10 shows an example of a product known as Replica Single where Customer 1 1060A acquires the initial Cone 1020 and has copied the contents 1070A to other customers 1060B to 1060D.

As described above the Cone 1020 is supplied by the publisher 1010 via the distributor 1030. The distributor interacts with the customer through a DMS 1040 that comprises an internet download portal 1041, a retail portal 1042, and a license registration product activation mechanism 1043. As shown in FIG. 10, the customer 1060A has obtained the Cone via download 1020A or as removable media 1020B. The customer enables the Cone, uses the license registration and product activation system 1043 to obtain a fully activated Cone running on the customer's host. The Cone includes the replica application that enables Customer 1 to create a replica 1070A which will include Customer 1's history record. Customer 1 can then distribute this to a number of customers, namely Customer 2 1060B through to Customer N 1060D. Customer 2 then activates and registers the license with the license registration product activation system 1043. This enables the second customer 1060B to create a further Cone replica 1070B that can be distributed to Customer 3 1060C through to Customer N 1060D.

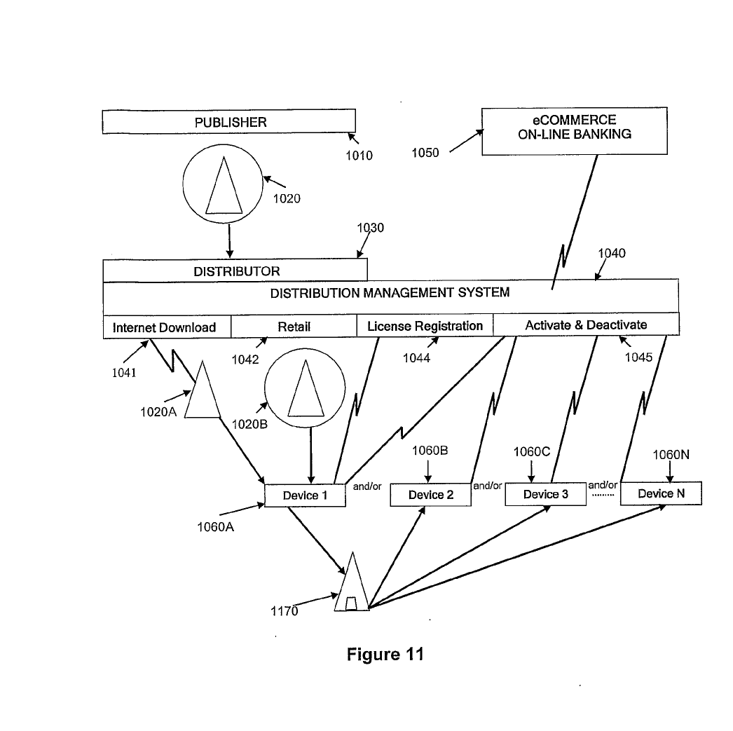

FIG. 11 shows an example of the Replica Personal and Portable license vehicles both of which allow operation of a Single license on multiple devices. Whilst the Personal vehicle may be activated on any number of devices 1060A through to 1060N simultaneously, a Portable license may only be activated on any one of “N” devices 1060A through to 1060N subject to prior deactivation on the previous device. Accordingly, the distribution management system 1040 is different in this embodiment in that it provides a capability for multiple activations as well as deactivation 1045. Therefore, in the case of the Personal vehicle, the Device 1 goes through a Single license registration process 1044 which is recorded in the Cone 1170 so that the Cone 1170 can be additionally activated on Device 2 through to Device N 1060B to 1060N. If supplied as Portable, the license must be subsequently deactivated and reactivated if supplied to any of devices 2 to N 1060B to 1060N.

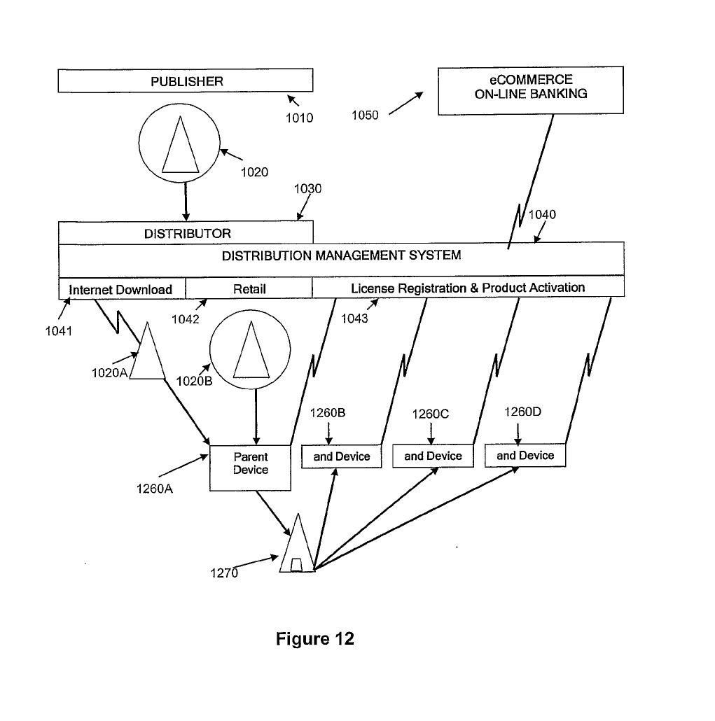

FIG. 12 shows an example of a product known as Replica Family which comprises a parent license packaged with (in this depiction) three included optional supplementary entitlements. The Family vehicle therefore behaves like the Personal vehicle but is limited in the number of devices on which the license can be activated. In this embodiment, the user registers the Cone 1020 on a parent device 1260A and there is an entitlement record enabling the user to subsequently register the Cone on up to three additional devices 1260B, 1260C and 1260D.

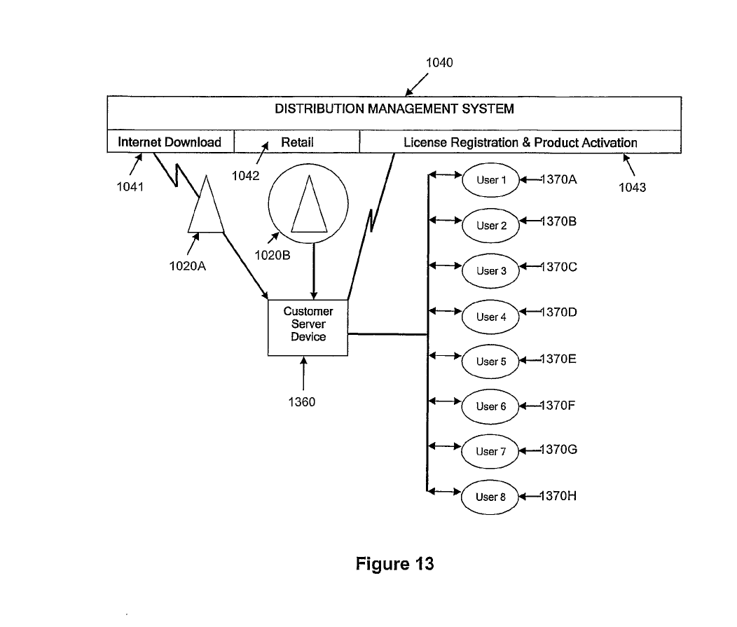

FIG. 13 shows an example of a Replica Server licence which supports up to eight connected users. The Cone delivered as 1020A or 1020B is registered on customer server device 1360. Whereafter known techniques for enforcing use of multiple licences on a server allows (in this depiction) up to eight connected users 1370A to 1370H to be connected and accessing the Cone at any one time.

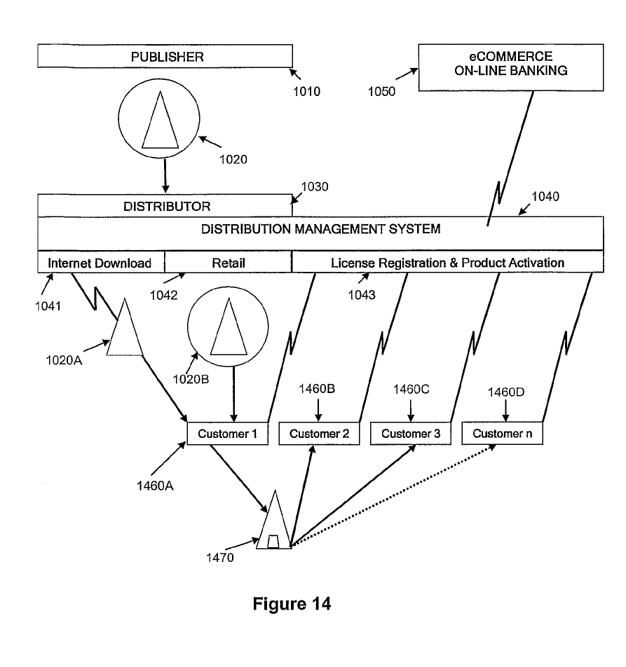

FIG. 14 illustrates an example of a customer using a Replica Bulk package to distribute N Replica Single, Personal or Portable licenses. The Cone delivered as 1020A or 1020B enables Customer 1460A to sub-distribute a Cone 1470 to further customers 2 through to N 1460B to 1460D.

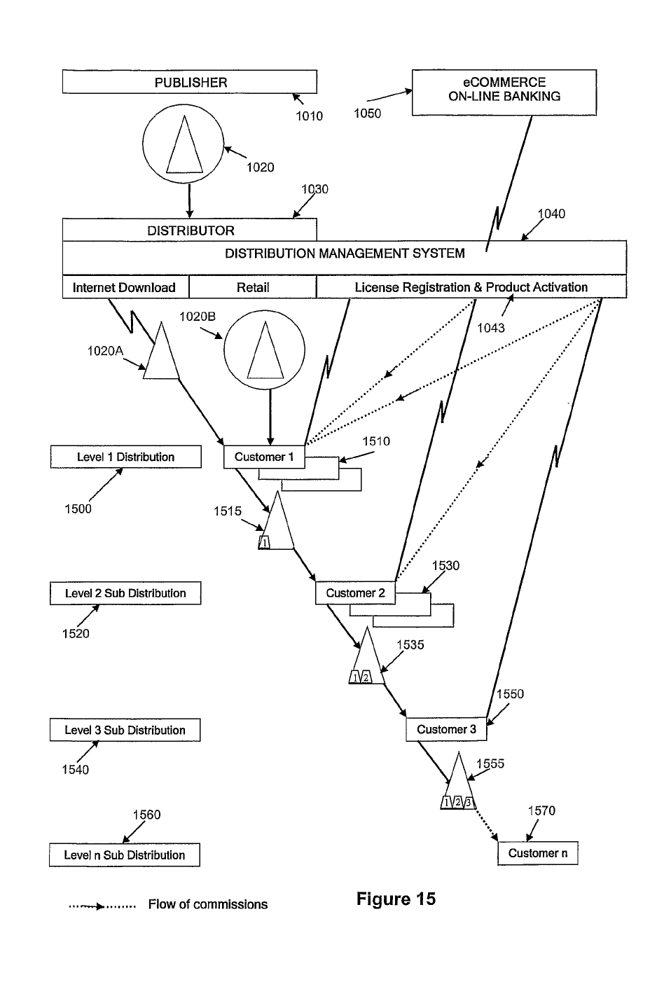

FIG. 15 shows a multilevel distribution model of a particularly preferred embodiment which allows customer sub distribution of Replica Single, Personal, Portable and Family licenses. In this model, there can be N levels of sub-distribution 1500, 1520, 1540, 1560.

In this model there may be a number of first customers 1510. If they make a replica Cone 1515 it includes a history record to indicate that it was produced by Customer 1. If they then supply it to Customer 2, when it is registered, the distribution management system 1040 is configured to match the history record to the customer and return a reward to Customer 1 1510. Similarly, at a second level of sub-distribution it can be distributed to Customer 2 1530 whose activation causes Customer 1 1510 to obtain a reward but who themselves may make a further copy 1535 which will then include both a history record of Customer 1 and a history record of Customer 2. If the product is registered and activated by Customer 3 1550 at the third sub-distribution level rewards will flow to both Customer 2 and Customer 1. Customer 3 may make a further copy and their history record will be included in replicated Cone 1555 which can be passed on to Customer N at the N'th level of sub-distribution.

### Further Details of Cone Assembly Processes

Integral to the notion of Cone assembly are the inseparable concepts of reassembly and disassembly which occur throughout its operational life following issue to its intended marketplace. By design, the Cone includes a history block which maintains a never-ending audit trail that commences with the creation of a new Project and concludes at the time the Cone was last accessed, used or redistributed.

The key to the functionality that can be delivered when Cone technology is applied depends on on-going automated maintenance and interpretation of the history block. Security of the information the audit trail contains also aids the underlying integrity of the activities the Cone itself supports and, accordingly, the level of protection available to dependent third party intellectual property and products.

The Cone is a sophisticated self-contained ‘database’ of information which represents a purpose built business model designed to deliver one or more protected third party products, to specific customers of a particular market. As such, and because the Cone contains all the logic required to secure its authorised release, it is the only object needed in order to oversee authorised supply, enable customer access and use, and to supervise product sub distribution if Bulk or Multilevel rights propagation is part of the implemented business model.

Access to the Cone history block tells the story of the life of the Cone and inherently supports forensic study of not only authorised Cone distribution and use, but also attempted tamper or misuse. Accordingly, analysis of the audit trail provides novel and unparalleled value when applied to market research and customer service activities or, conversely, provides a basis for litigation if a copyright offence is deemed to have been committed.

Table 3 provides an overview of Product Release Cone assembly processes discussed in further detail below.

TABLE 3

| Cone Type | Tag | Privilege | Permission | Activity and Details |
|---|---|---|---|---|
| Project | prjf | Publisher | Publish | Enter participants |
| | | | | Define publisher |
| | | | | Initialise owner & producer details |
| | | Each Owner | Publish | Finalise participant owner definition |
| | | | | Update producer definition(s) |
| | | | Included Data | Enter included data product definitions |
| | | | Products | Define intellectual property groups, |
| | | | | components and stakeholders |
| | | | | Initialise replication rules |
| | | Each Producer | Publish | Finalise participant producer definition |
| | | | Included Data | Introduce predefined intellectual |
| | | | Products [A] | property components |
| Market Model | dstf | Publisher | Publish | Enter participants |
| | | | | Define distribution chain and |
| | | | | customer profiles |
| | | | Enter products | Define included products and pricing |
| | | Each Producer | Included Data | Add predefined data products not |
| | | | Products [B] | included at [A] |
| | | and/or Publisher | Include product IP | Add protected product components |
| | | Each Distributor | Publish | Finalise participant distributor definition |
| License | licf | Publisher | License | Set licenses |
| | | | | Define license types and conditions |
| | | | | Set upload rules |
| | | | | Define license registration and |
| | | | | product activation constraints |
| | | | | Finalise replication rules |
| Product Release | | Publisher | Compile release | Runable Versatile Device [RVD] |
| Cone or | conf | and/or Producer | Included items | Define included software components |
| Cabinet | cabf | | Product release | Define included resource files |
| | | | | Define launch conditions |
| RVD | | Publisher to | Distribution Kit | Compile kit |
| | | Distributor | | Include distributor tools kit |

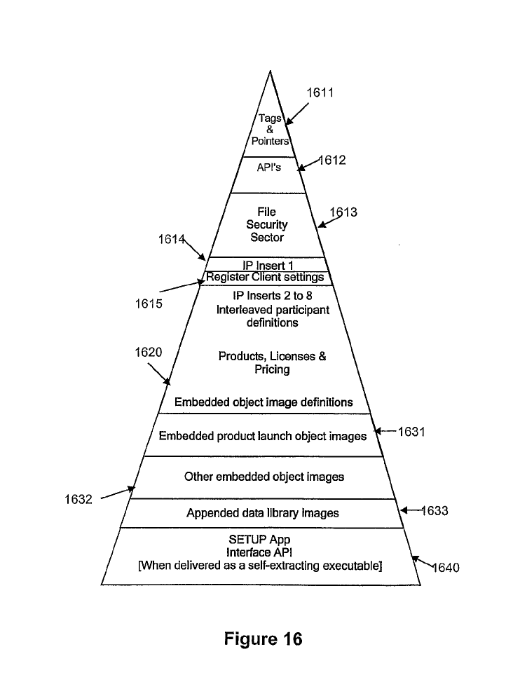

The publication process, which starts with the creation of a new Project and ends with the creation of a Cone or Cabinet (RVD) that contains a product release, is one of assembly. FIG. 16 provides a schematic view of the Cone and its contents and includes reference to the history block which is contained in the File Security Sector. The view shows the logical components which comprise a Cone; viz. the autoloader 1611-1615, model definitions 1620 and embedded objects 1631-1633. Appended at the base of the Cone is the optionally included self-extracting executable segment which transforms the Cone into a Cabinet.

The Cone autoloader segment includes all the components and settings called on by the general purpose interface API shown as part of the Cabinet addition at the base. A key feature of later Cone release processes is that autoloader logic remains independent of the interface API component and, accordingly, is divorced from the set up process itself.

The Cone autoloader consists of tags and pointers 1611 which include a public file identifier, file type tag, file version and in memory encryption version as well as a custom encryption API pointer, history block pointer, included data product index pointer, and embedded objects index pointer, which are all private in nature.

There are also API's 1612 which include a cone interpreter (the payload interpreter), and a terminology handler. Also part of the API layer 1612 is an application which oversees on-line registration and host device local registration (index) of enabled Cones.

File security sector 1613 includes a system file header, file encryption markers, file history block and an encryption API image or key(s), as well as a file security block which includes a custom encryption API image or key(s) and an included data product index. IP insert 1614 includes the intellectual property which is the set of data products included in the package and is a first of eight intellectual property insertion points. Register client settings 1615 dictate enablement requirements of a Cone as well as registration and activation conditions.

The model definitions 1620 section contains all required participant details and intellectual property object images (if included) in support of one or more product definitions. License settings, default product pricing and the embedded object definitions also reside in this section. Finally, the embedded objects section 1632 houses all public and private components and resources required to support operation when public embedded product launch object images 1631 are executed.

The model definitions include intellectual property insert blocks 2 to 8, a list of available products, price group definitions and embedded object image definitions.

The embedded objects include embedded product launch object images 1631, other embedded object images 1632 which may be program objects, source file objects, participant help files, branding object images or data library images 1633.

The application component on which the publication process depends is known as the ConeStructor which itself can be supplied as a licensed and protected product delivered in the form of an RVD or Cone. A delivered ConeStructor Cone includes an autoloader which becomes the default autoloader when the project which underpins all subsequent development of the business model is first created.

Accordingly, a new Project Cone is initiated as an autoloader segment from which the history block has been cleared and all API objects and original settings are preserved. From this beginning, the Cone is subjected to the Model definition, License creation and Product Release processes, each of which adds new information to the accumulating ‘database’ the Cone represents.

### Further Details of Cone Release

Table 4 provides an overview of Cone release processes discussed in the Supply, Cone Release and Redistribution sections which follow, and again includes references to audit trail creation.

TABLE 4

| Cone Type | Tag | Privilege | Permission | Activity and Details |
|---|---|---|---|---|
| RVD | conf or | Customer | Select product(s) | Using OSC on-line |
| | cabf | Virtual Direct | Supply | Enable and perform download |
| | | | Enable Cone | Upload Cone as read and write, |
| | | | | Register enabled on specific host, and |
| | | | | Enable OSC off-line |
| | | | Register | Enable Cone license |
| | | | Activate | Enable product activate or reactivate |
| | | | Family | Enable activate secondary entitlement |
| | | | Deactivate | Disable product activation |
| RVD | conf | Customer | Enable Cone | As for Virtual Direct |
| | | By Proxy | Select product(s) | Using OSC off-line |
| | | | Register by proxy | Perform Cone license registration and |
| | | | | Selected product activation(s) |
| | | | Enable use | Provide ready-to-run updated Cone |
| RVD | conf | Customer | Replicate | Enable sub distribution of all or part |
| | | Indirect | | of a Cone |

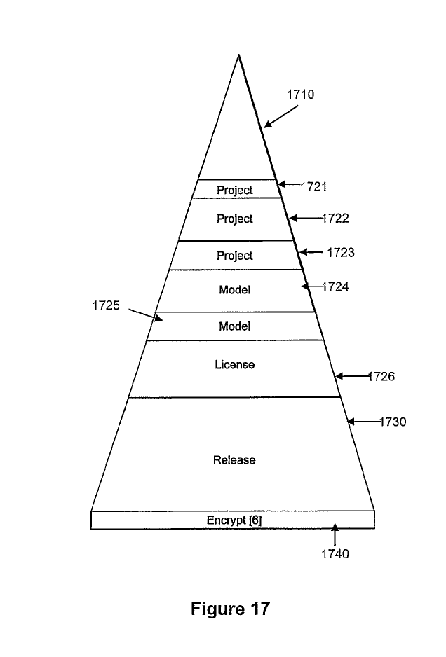

FIG. 17 illustrates how ongoing maintenance of the history block throughout the life of a Cone underpins the enablement of its unique functionality and provides a basis for its subsequent consistent interpretation. Each history record includes data related to hardware configuration and physical device identification, operating environment and logical device usage and regional and user settings.

Each record also enables enforcement of licence and enablement related use-by-date provisions without requiring internet access. History records which are included in the audit trail belonging to the Cone Product release process are illustrated in FIG. 17. The history record is illustrated schematically as a Cone 1710. History records are included for the publisher 1721, each owner 1722, and each producer 1723 for the project. Records for the market model are included for the publisher 1724 and for the publisher or producer 1725. A licence history record is also included for the publisher 1726.

On completion of Product Release publication and prior to issue of the Cone as a Cabinet, a single Release history record 1730 is included.

An encrypt history record 1740 may also appear in the trail (chronologically) if an owner in the process for release has decided to apply a custom encryption API or key(s) referred to previously as decrypt 3.

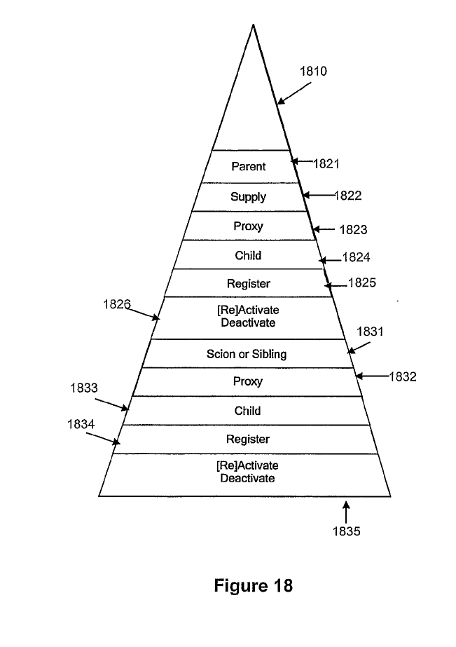

FIG. 18 shows the history update 1810 following the Product Release described at FIG. 17. As indicated by FIG. 18, the history record will include a Parent record 1821, a Supply record 1822 per online download or retail issue. It may include a Proxy record 1823 associated with a proxy host or retail registration or activation, a Child record identifying the licensed customer host 1824 and one Cone Register record per host 1825. It also includes one Activate/Deactivate record 1826 per enabled product per host device. Whilst the above always applies to customer direct distribution, for customer indirect sub distribution there may be a single Scion or Sibling record 1831, followed by a further Proxy record 1832, a further Child record 1833, a subsequent Register record 1834 as well as additional activate and deactivate records 1835.

### Cone Release Summary

The Cone release process manifests itself in three logically distinct phases; viz.
Action required in order to enable and register the Cone,
Action required in order to activate one or more included products, and
Action recommended in order to protect a product during each runtime instance.

The primary purpose of the Cone release process is to unravel all the applications, components and data required for a protected third party product to operate in the manner contemplated by its owner, without being visible or introducing unnecessary processing overhead. Indeed, it is intended that legitimate users of a protected product should be unaware of the security and protection measures invoked when their access and use is conducted in the manner authorised. Release of Cones is managed using the interface API, under protected product launch control.

The design of the Cone, and the processes which oversee its release, recognise that effective enforcement of protection conditions relies on rechecking all security measures prior to allowing access to or use of any product the Cone contains, and that all checks must be conducted on each and every occasion the product is launched. The design of the interface API also allows reassessment of static and dynamic security status when triggered by events that occur at protected product runtime.

As described above the Cone is a self contained computer file incorporating an integrated mix of logic, protected data product, protected objects and data resources. When supplied as part of an RVD, a Cone also behaves as a self-extracting executable application.

Because the Cone itself contains all the logic and resources required to oversee its secure release, the specific methods applied in the process and, in particular, encryption techniques and certificated keys are layered so that decryption requirements always differ from one Cone to another. In other words, the processes embodied or implied in release of a Cone can be tailored to meet the specific needs of a protected application or product, and any defect which might be exploited in one Cone can readily be circumvented in any subsequent release. Additionally, certain aspects of the protection offered by encryption techniques are field upgradeable thereby enabling repairs to be affected in the event that a Cone is compromised through abuse or tamper.

As explained above, the executable relevant to providing the interface API to the host, the Setup application, can be provided independently to the user, for example by internet download or as part of an RVD. It may often be provided separately in order to avoid problems with internet fire walls. The Setup application automatically extracts, decrypts, decodes, stores and registers the interface API component. Once this component is present on the host platform, all the processes required for the controlled release and operation of protected products belonging to any previous, current or future Cone delivery exist, and product launch shells will operate in the manner intended. A number of other applications including the Replica application and the generic product launch shell are also initiated using the interface API. The Product App is typically provided as a generic launch shell embedded within the Cone.

In Summary, the initial release process involves the following steps:
1. launching the Setup application,
2. verifying the file tags
3. enabling compiled in encryption,
4. buffering the Cone history block,
5. enabling a Cone read API,
6. ensuring the Cone is writable,
7. appending a Child history,
8. registering the Cone as enabled,
9. releasing the Cone information and help,
10. releasing product launch shells,
11. launching the flagship product shell,
12. terminating the interface API, and
13. terminating the Setup application.

When activating and running a protected product the activation process involves:
1. repeating above steps 2 to 5 of the enablement process,
2. enabling the inbuilt encryption API or applying decryption key(s),
3. enabling any custom encryption API or applying decryption key(s),
4. buffering participant details,
5. enabling terminology API,
6. enabling participant help,
7. enabling off-line shopping cart,
8. enabling the host registration (Cone indexing) API,
9. enabling the web client API.

Then if a proxy host is being used to register and activate,
1. accept customer details entry,
2. fill the offline shopping cart,
3. create the Replica application,
4. run the Replica application on a proxy host,
5. conduct a web session dialogue,
6. update the Replica application,
7. copy the updated Replica application to media,
8. run the Replica application on the original host,
9. append the proxy history,
10. append the license history,
11. record Cone enablement in the host local index,
12. append product history,
13. update product availability in the host local index,
14. commence protected product runtime.

Protected product runtime involves,
1. launching the protected product,
2. repeating steps 1 to 9 of the activate process,
3. retrieve included objects,
4. retrieve object images,
5. retrieve object references,
6. retrieve included protected products,
7. cycle on monitor active status,
8. cycle on monitor dynamic status,
9. act on invalid static tamper status,
10. act on invalid dynamic tamper status, and
11. repeat the monitoring steps until the protected runtime is complete and then the interface API is terminated and the product runtime ends.

Persons skilled in the art will appreciate that there may be a number of variations to the preferred embodiment and it is not intended for the invention to be limited to this embodiment.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A computer implemented method of controlling release of a data product to a host, comprising:
providing a data parcel to a host comprising: (i) a payload interpreter accessible by an interface application program interface (API) for operation by the host and (ii) a data payload readable by the payload interpreter comprising reference data describing at least one data product;
accessing the data parcel with the interface API;
enabling the data parcel in response to the data parcel being accessed with the interface API; and determining that the data parcel is enabled before allowing the host to operate the payload interpreter to read part or all of the data payload.

2. A computer implemented method as claimed in claim 1, wherein enabling the data parcel comprises altering the data parcel to include a history record to indicate that the data parcel has been enabled on the host.

3. A computer implemented method as claimed in claim 1, comprising conducting a check to determine that the data parcel includes a history record and that the payload interpreter is available for use.

4. A computer implemented method as claimed in claim 1, wherein the data payload contains at least one data product specified by the reference data.

5. A computer implemented method as claimed in claim 1, wherein the reference data specifies at least one data product not in the data parcel.

6. A computer implemented method as claimed in claim 4, wherein the at least one data product is encrypted.

7. A computer implemented method as claimed in claim 3, wherein the step of conducting a check further comprises checking that the data parcel is enabled on the host.

8. A computer implemented method as claimed in claim 1, comprising providing the reference data to the host after conducting the check, the reference data identifying the data product and including at least one condition for decryption and release of the data product, the method further comprising determining that each condition has been complied with prior to decrypting and releasing the data product.

9. A computer implemented method as claimed in claim 1, wherein the payload interpreter is encrypted and is decrypted by the interface API by a first decrypter of the interface API.

10. A computer implemented method as claimed in claim 9, wherein a second decrypter is decrypted by the first decrypter and the reference data is encrypted, and the method comprises decrypting the reference data with the second decrypter.

11. A computer implemented method as claimed in claim 4, wherein there are a plurality of data products and at least some of the reference data is presented to a user of the host in the form of an off-line shopping cart in order to allow the user to select at least one data product.

12. A computer implemented method as claimed in claim 1, comprising delivering the interface API with the data parcel.

13. A computer implemented method as claimed in claim 1, comprising delivering the interface API independently of the data parcel.

14. A computer implemented method as claimed in claim 11, comprising delivering the off-line shopping cart with the interface API.

15. A computer implemented method as claimed in claim 4, comprising enabling each selected data product by altering the data parcel to include a history record to indicate that the data parcel may be accessed on the host, and rendering each selected data product available for subsequent access and/or use.

16. An electronic data parcel for distribution of at least one data product comprising:
(a) a payload interpreter accessible by an interface API for operation by a host; and
(b) a data payload readable by the payload interpreter and containing at least one data product, the data parcel being configured to require the data parcel to be enabled on the host before allowing the host to operate the payload interpreter to read part or all of the payload.

17. An electronic data parcel as claimed in claim 16, wherein the data payload contains at least one data product specified by the reference data.

18. An electronic data parcel as claimed in claim 16, wherein the reference data specifies at least one data product not in the data parcel.

19. An electronic data parcel as claimed in claim 17, wherein the at least one data product is encrypted.

20. An electronic data parcel as claimed in claim 16, wherein the payload interpreter is encrypted and is decryptable by the interface API by a first decrypter of the interface API.

21. An electronic data parcel as claimed in claim 20, wherein a second decrypter is decryptable by the first decrypter and the reference data is encrypted, and the reference data is decryptable with the second decrypter.

22. An electronic data parcel as claimed in claim 16 comprising the interface API.

23. (canceled)

24. An electronic data parcel as claimed in claim 16 comprising delivering an off-line shopping cart.

25. A computer implemented method of monitoring release of a data product comprising:
distributing at least one data product by providing a data parcel containing at least one data product and a payload interpreter required to access at least one data product; and
altering the data parcel during a process for release of the data product to include a history record specific to the host on which the data parcel has been previously enabled, whereby if the data parcel or a further data parcel derived from the data parcel is distributed from the host to a further host after the data parcel has been enabled, the data parcel or further data parcel includes a history record of the previous host.

26. A computer implemented method as claimed in claim 25, comprising linking registration of at least one data product by the further host to any registration made by a previous host based on the history record.

27. A computer implemented method as claimed in claim 25 comprising enabling hosts to generate further data parcels comprising all or part of the original data parcel for sub-distribution.

28. An electronic data parcel arranged to enable release of a data product, the data parcel comprising:
a payload including a data product; and
a payload interpreter required to read part or all of the payload,
the data parcel configured such that during a process for release of the data product, the data parcel is altered to include a record of the host on which the data parcel is enabled, whereby if the data parcel or a further data parcel derived from the data parcel is distributed from the host to a further host after the data parcel has been enabled, the data parcel or further data parcel includes a history record of the previous host.
